(19) United States
(12) Patent Application Publication
(10) Pub. No.: US 2010/0173062 A1
(43) Pub. Date: Jul. 8, 2010

(54) Method for the production of sausage products based on fish meat and sausage products containing fish meat

(76) Inventors: Peter Eisner, Freising (DE); Klaus Müller, Freising (DE); Christian Zacherl, Freising (DE); Jürgen Hautz, St. Wendel (DE)

Correspondence Address: Friedrich Von Rohrscheidt, 7400 Whitepine Road, Richmond, VA, 23237, US

(21) Appl. No.: 12/592,661

(22) Filed: Dec. 1, 2009

Related U.S. Application Data
(63) Continuation of application No. PCT/DE2008/000182, filed on Feb. 1, 2008.

(30) Foreign Application Priority Data
Jun. 1, 2007 (DE) 10 2007 025 847.1

(51) Int. Cl. A23L 1/317; A23L 1/325

(52) U.S. Cl. 426/574; 426/643

(57) ABSTRACT

A method for producing sausage products based on fish meat, wherein fish meat is processed with ice to provide a base meat. The ice is at a temperature below minus 10° C. and that at least part of the fish meat comes from a fresh water catfish of the genus Heterobranchia.

### RELATED APPLICATIONS

This application claims priority from and incorporates by reference German patent application serial No. DE 10 2007 025 847.1, filed on Jun. 1, 2007 and International patent application PCT/DE2008/000182, filed on Feb. 1, 2008.

### FIELD OF THE INVENTION

The invention relates to a method for producing sausage products based on fish meat where the fish meat together with ice is processed into a base meat and sausage products containing fish meat wherein at least a portion of the fish meat comes from freshwater catfish of the genus Heterobranchidae and plant protein is added to the fish meat.

### BACKGROUND

A method of this type or sausage products of this type are known from WO 93 00 830. In this known method, fish meat in frozen or partially frozen state is cut into pieces together with ice and mixed into a base meat. The ice comes from a freezer and typically has a temperature above −5° C. Meat from tuna, shark or from trout is used for fish meat. In order to achieve coherence and consistency, which is sufficient for typical scalding sausage products or cutting sausage products, plant oil is added during the known production process. Thus, coherence or consistency designates a property of the base meat, which leads to a typical pleasant texture of the sausage products. Coherence that is too low leads, for example, to a crumbling inhomogeneous texture and to a texture which is too soft.

Known sausage products which are made from fish meat include a typical fish flavor. The main reason for this is, besides the selection of the raw materials, in particular the temperature during the production of the base meat in the cutter. Thus, typical fish flavors develop rather quickly due to the elevated temperatures occurring at the cutter blades during conventional processing. Consequently, the sausage material includes a substantial amount of flavors after cutting which are formed during the oxidation of fish components. These substances are described with features like “fishy” or typical for fish when tasting fish products. This taste leads a portion of the population to dislike fish products, which is also a reason that sausage products based on fish have failed to capture any significant market share.

### SUMMARY OF THE INVENTION

Thus, it is an object of the invention to provide a method for producing sausage products based on fish meat, which have at least approximately the texture of conventional sausage products based on meat from mammals or poultry with respect to coherence and consistency. Forming this texture is achieved in particular without adding additional fats.

Furthermore, the taste of the sausages made by the process is not too close to fish taste.

This object is accomplished through, for example, by producing sausage products based on fish meat where the fish meat together with ice is processed into a base meat where the ice has a temperature of less than −10° C. and at least a portion of the fish meat comes from freshwater catfish of the genus Heterobranchidae, and wherein plant protein is added to the base meat. This object is also accomplished where the fish meat is exclusively selected from the freshwater catfish of the genus Heterobranchidae.

### DETAILED DESCRIPTION

A method according to the invention is based on the idea that the ice used for producing the base meat has a temperature of less than −10° C., and that at least a portion of the fish meat comes from freshwater catfish of the genus Heterobranchidae.

Thus, the applicant has discovered that the meat of these fish has quite neutral taste properties, this means that the taste of sausage products based on the meat of these fish does not taste very fishy, which may facilitate a better reception by consumers, who rather dislike the typical fish taste. For meat exclusively, the fish meat of the fresh catfish can be used, but additionally also meat from mammals or from poultry, wherein the percentages can be varied depending on the desired properties.

When attempting to produce a base meat for sausage products from the flesh of these fish, it furthermore comes as a surprise that no additional fat or oil has to be added, in order to achieve an excellent coherence of the base meat and excellent properties of the sausage products.

Since no additional fat had to be added, when producing sausage products from the meat of the fish recited supra, sausage products with overall fat content of less than 7% can be achieved. When using particularly low fat fillets of this fish, even a fat content of less than 3% can be achieved without negatively influencing the coherence of the base meat. The fish meat employed should have a fat content of less than 7%, particularly preferably less than 5%. This achieves a very lean base meat mass with a fat content of less than 5%, preferably less than 4%. In some trials with particularly selected fillet pieces, even sausage products with fat contents below 2% could be obtained.

Depending on consumer preference, however, it is also possible to increase the fat content of the sausage products by adding various amounts of additional fats or additional oils.

Furthermore, it has become evident that when preparing base meat by adding very cold ice with temperatures below −10° C., the coherence and consistency of the sausage produced there from, which is good through using special fish meat anyhow, can be increased even further. Thus, the relatively low temperature of the ice provides that the proteins included in the fish meat are broken down or solubilized better, wherein well solubilized proteins or well dissolved proteins are capable of absorbing large amounts of water. Thus, the relatively cold ice used in the cutting process facilitates embedding large amounts of water into the sausage matrix, which increases the juiciness and coherence of the fish sausage products.

Various advantages can be derived by producing a base meat for the fish sausage by cutting fish fillet from Heterobranchidae together with very cold ice with a temperature of less than −10° C., optionally together with salt and/or nitrate curing salt and/or spices and/or cutter helper, but without adding additional fat like bacon, oil or fat replacement substances, which are not provided in the fish meat already, and without adding colorants in a cutter.

Further various advantages with respect to coherence and texture of the base meat could also be implemented by using fish meat of a cross breed between Clarias gariepinus and Heterobranchus longifillis, which both belong to the genus of Heterobranchidae. When using fish meat from this cross breed, a very neutral taste without fishiness and a very juicy texture of the sausage products is very typical without having to add additional fat or additional oil.

The base meat thus obtained can be used as a basis for a plurality of scalding sausage products, like Lyonese sausages, ham sausage, wieners, baked pâté, scalding sausages with ingredients or similar. When regular table salt is used instead of nitrate curing salt during cutting, also bratwurst, Bavarian veal sausages or variations of baked pâtésausages can be produced.

The texture becomes particularly appealing when the entire ice is added at the beginning of the cutting process, wherein the ice has a temperature of less than minus 10° C., particularly preferably less than minus 20° C., and the mass percentage of the ice with reference to the entire mass of the base meat is at least 20%. With respect to the taste impression “juiciness”, it is advantageous to adjust the ice content to values between 20% and 45%.

The ice volume used for producing the base meat is sized so that a specific amount of energy of at least 100 kJ/kg is removed from the base meat until the added ice is melted, preferably more than 125 kJ/kg, particularly preferably more than 150 kJ/kg, with reference to the mass of the base meat.

With respect to the health properties of food products, also the fatty acid composition is an important criterion in sausage products besides the total fat content. It shall also be attempted to process a content of omega 3 fatty acids into the sausage products, which is as high as possible, without simultaneously raising the fat content excessively.

Enrichment with omega 3 fatty acid can be implemented in particular with plant oils, which are rich in omega 3 fatty acids, like e.g. rapeseed oil. Also for this nutrition physiological aspect, the sausage product according to the invention has significant advantages. Through the strong coherence of the raw material in combination with the production at low temperatures, the fat or oil type can be freely selected independently from the viscosity. In many cases, this is not possible, since low viscosity oils can exit from the sausage matrix very easily. In the product according to the invention, the fat content can be increased up to a value of approximately 10% without suffering any degradation in the sausage texture. Thus, it becomes apparent that the texture is advantageous in particular when a total fat content of 8% is not exceeded by adding plant oils to the sausage. When adding higher amounts of oil, oil can exit from the matrix. The product then becomes fatty, which is disliked by the consumers.

Some consumers take care in their nutrition that the ratio of certain amino acids is advantageous from a nutrition point of view. In order to improve the amino acid spectrum of fish meat, it is advantageous to add plant protein. This can come, for example, from peas, soy beans, lupines or field beans. Adding plant protein up to 8% with reference to the total base meat mass is particularly advantageous. This yields a sausage product with a very well balanced amino acid ratio, which is very advantageous from a nutrition physiological point of view.

Based on the surprisingly good coherence properties of the fish meat coming from Heterobranchidae, it is even possible to produce raw sausage products like salami or raw sausage spread without adding fat, which have taste properties that are comparable with raw sausage products with full fat content.

Furthermore, additions of non-soluble micro-particulate or micro-spherical protein products made of plant protein and/or milk protein are advantageous when producing raw sausage spread products are particularly advantageous. This helps to achieve a particularly supple texture and a very smooth sensation in the mouth without requiring an addition of non indigenous fats.

According to another embodiment, adding plant oils with a high percentage of omega 3 fatty acids can be advantageous in order to enrich the sausage products with the valuable omega 3 fatty acids. According to another embodiment, the raw sausage products can be enriched with plant protein in order to increase the arginine content of the product. Adding up to 10% of lupine protein or pea protein is advantageous in particular.

By the same token, cooked sausage products like e.g. liverwurst spread or liver pâtécan be produced from fish fillet coming from Heterobranchidae and from the liver of these animals. It has become evident that a particularly creamy cooking sausage is produced when the fish meat is not cooked before cutting, but scalded at temperatures of less than 85° C., preferably less than 75° C. This achieves a particularly juicy sausage structure.

The preferred cutter temperature for producing cooking sausage base meat from the fresh fish liver and from the scalded fish meat is more than 40° C., particularly preferably more than 50° C. This solubilizes the fish liver particularly well.

According to an alternative, the fish meat and the fish liver are cut dry at the beginning of the cutting process, this means cut initially without ice or water and the remaining ingredients, among others ice or water, are added only shortly before the end of the cutting process. This process facilitates omitting emulsifiers as additives.

The creaminess in the sausage can be improved when up to 3% hydrocolloids based on carbohydrates are added when the sausage produced in the cutter. Particular advantages can be derived when using xanthan gum in weight percentages of 0.5 to 1% of total mass.

The creaminess in the sausage can also be improved when up to 4% plant protein is added during the processing in the cutter. Particularly positive properties are achieved when using legume proteins like lupine proteins. After adding lupine protein in the cutter, cooking sausages spread very smoothly and become very creamy, in spite of the low fat content of less than 3%. This works very well when adding non-soluble micro-particulate or micro-ball shaped protein products made of plant protein and/or lactic protein. When the heating temperature of the cooking sausage filled into the guts or glasses is kept below 75° C., the spreading properties are good in particular, since no complete de-naturization of the plant proteins is performed. The use of humid plant proteins or frozen watery protein solution is advantageous since the protein solubility is particularly high here.

The structure of the cooked sausage can be improved by adding fiber products; commercial fiber products, for example, made of wheat, legume or oats are particularly suitable.

A particularly creamy structure is obtained when the scalding temperature is just below the de-naturization temperature of the plant proteins, but above the de-naturization temperature of liver and above the required pasteurization temperature.

According to a particular embodiment of the method for producing a liverwurst, the scalding process is performed at heating and cooling rates below 5 K/min.

Bioactive sausage products can be obtained when secondary plant contents are added.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A method for producing sausage products based on fish meat comprising:
processing fish meat together with ice to form a base meat,
wherein the ice has a temperature of less than −10° C.;
wherein at least a portion of the fish meat comes from freshwater catfish of the genus Heterobranchidae; and
wherein plant protein is added to the base meat.

2. A method according to claim 1, wherein the fish meat from freshwater catfish of the genus Heterobranchidae is used exclusively.

3. A method according to claim 1, wherein at least a portion of the fish meat comes from a cross breed between a Claris Gariepinus and a Heterobranchus longfillis.

4. A method according to claim 1, wherein the base meat only includes fish meat.

5. A method according to claim 1, wherein the fish meat used for producing the base meat mass has a fat content of less than 7%.

6. A method according to claim 5, wherein the fat content is less than 5%.

7. A method according to claim 5, wherein the fat content is less than 3%.

8. A method according to claim 1, wherein salt and/or nitrate curing salt and/or spices and/or cutter helper are added for producing the base meat.

9. A method according to claim 1, wherein fish meat at least in combination with the ice is processed into base meat in a cutter.

10. A method according to claim 9, wherein the ice is added at the beginning of the cutting process.

11. A method according to claim 9, wherein the fish meat is partially frozen before the cutting process, but not completely frozen, so that its average temperature is less than 5° C., preferably less than 1° C., but not less than 0° C.

12. A method according to claim 11, wherein the fish meat is partially frozen before the cutting process to an average temperature of less than 1° C.

13. A method according to claim 9, wherein hydrocolloids based on carbohydrates are added to the base meat during the cutting process.

14. A method according to claim 13, wherein the hydrocolloids based on carbohydrates are xanthan gum and carboxymethylcellulose.

15. A method according to claim 9, wherein the cutting of the base meat is performed so that the temperature of the base meat at the end of the cutting process is 10° C. at the most.

16. A method according to claim 15, wherein the cutting of the base meat is performed so that the temperature of the base meat at the end of the cutting process is 8° C. at the most.

17. A method according to claim 1, wherein the ice has a temperature of less than minus 20° C.

18. A method according to claim 1, wherein a mass percentage of the ice with reference to a total mass of the base meat is between 20% and 45%.

19. A method according to claim 18, wherein an amount of ice used for producing the base meat is sized, so that a specific amount of energy of at least 100 kJ/kg with reference to the base meat is removed from the base meat until the added ice is melted.

20. A method according to claim 18, wherein an amount of ice used for producing the base meat is sized, so that a specific amount of energy of more than 125 kJ/kg with reference to the base meat is removed from the base meat until the added ice is melted.

21. A method according to claim 18, wherein an amount of ice used for producing the base meat is sized, so that a specific amount of energy of more than 150 kJ/kg with reference to the base meat is removed from the base meat until the added ice is melted.

22. A method according to claim 1, wherein the plant protein is from a lupine or pea.

23. A method according to claim 1, wherein the base meat is being cooled in addition to being cooled through the ice.

24. A method according to claim 1, wherein soluble or non-soluble ballast materials are added to the base meat.

25. A method according claim 24, wherein the soluble or non-soluble ballast materials are grain fibers, leguminous fibers, citrus fibers, glucanes or pectines.

26. A method according to claim 1, wherein insoluble micro-particulated or micro-spherical protein products made of plant protein and/or lactic protein are added to the base meat for producing a spreading sausage.

27. A method according to claim 1, wherein at least one plant oil is added to the base meat.

28. A method according to claim 27, wherein the added oil content is less than 10%.

29. A method according to claim 27, wherein the added oil content is less than 8%.

30. A method according to claim 1, wherein the base meat is produced without adding additional fat like lard, oil or fat substitutes that are not already present in the fish meat.

31. Sausage products made of fish meat like raw sausages, scalding sausages or cooking sausages or spreadable cooking sausages produced according to a method of claim 1.

32. Sausage products comprising:
raw sausages, scalding sausages, cooking sausages or spreadable cooking sausages, each of which includes fish meat, wherein at least a portion of the fish meat comes from freshwater catfish of the genus Heterobranchidae and plant protein is added to the fish meat.

33. Sausage products according to claim 32, wherein the fish meat is exclusively from freshwater catfish of the genus Heterobranchidae.

34. Sausage products according to claim 32, wherein no other fats, lard, oil or fat substitutes are added to the sausage products that are not already present in the fish meat, and that fat content of the sausage products is less than 7%.

35. Sausage products according to claim 34, wherein the fat content is less than 5%.

36. Sausage products according to claim 34, wherein the fat content is less than 3%.
